(19) United States
(12) Patent Application Publication
(10) Pub. No.: US 2025/0249713 A1
(43) Pub. Date: Aug. 7, 2025

(54) ROCKER BODY

(71) Applicant: WHITE MULE COMPANY, Ontario, OH (US)

(72) Inventors: Larry Steven Ritchey, Mansfield, OH (US); Andrew Patrick Ritchey, Mansfield, OH (US)

(21) Appl. No.: 19/046,835

(22) Filed: Feb. 6, 2025

Related U.S. Application Data
(60) Provisional application No. 63/550,313, filed on Feb. 6, 2024.

(51) Int. Cl. B60D 1/48

(52) U.S. Cl. CPC B60D 1/486

(57) ABSTRACT

A rocker body assembly includes a rocker body having a top surface with a hook formed thereon and a bore having an oval cross-section formed through the rocker body. The bore includes a crescent-shaped surface adjacent the hook and a primary surface formed on the top surface. A channel formed in the primary surface extends into the oval cross-section of the bore. A J-bolt having a threaded end and a hook end may be slidably disposed through the bore and channel, with a washer and threaded fastener engaging the threaded end to generate a clamping force securing an axle between the hook of the rocker body and the hook end of the J-bolt. The crescent-shaped surface enables rotational alignment of the J-bolt within the bore to accommodate axles of various sizes and is configured to reduce bending stresses and torque applied to the washer, the J-bolt, and the threaded fastener.

### CROSS-REFERENCE TO RELATED APPLICATIONS

This application claims the benefit of U.S. Provisional Application No. 63/550,313, filed on Feb. 6, 2024. The entire disclosure of the above application is incorporated herein by reference.

### FIELD

The present disclosure relates generally to devices for the transportation of vehicles and, more particularly, to an improved rocker body configuration for coupling vehicles together for transport.

### INTRODUCTION

This section provides background information related to the present disclosure which is not necessarily prior art.

Various devices may be used for coupling vehicles together for purposes of either towing a disabled vehicle or for shuttling vehicles between multiple locations. A saddle-mount may be used to couple a lead vehicle to a towed vehicle or a combination of vehicles. In truck applications, the saddle-mount may be mounted to either a fifth wheel or to a frame of the lead vehicle. The saddle-mount is then generally coupled to the front axle of the towed vehicle, such that the front of the towed vehicle is lifted from the ground, and the towed truck rolls only on its rear wheels. Alternatively, multiple saddle-mounts may be used in combination to attach additional vehicles to each other. Up to three saddle-mounts may be used to transport a maximum of four trucks in total. The saddle-mount may be configured with a saddle bolster, as a lower half of the saddle-mount, where the saddle bolster is used to secure the saddle-mount to either the frame or fifth wheel of the towing or lead vehicle. A saddle head, as an upper half of the saddle-mount, may be used for securing and retaining the front axle of the vehicle being towed.

Certain saddle head designs include the use of a “rocker” and “J-bolt” assembly. Certain rocker bodies and J-bolts may not accommodate certain vehicle axle sizes. Ill-fitting axles may cause undue stress on the rockers and J-bolts during operation. This may be compounded by a growing trend toward larger vehicles that have larger axles with larger bottom flanges. Additionally, larger vehicles are typically heavier, necessitating larger tow capacities.

Accordingly, there is a continuing need for a high strength rocker body assembly that may accommodate varying sizes of truck axles while providing proper fit and clamping force on the axle in conjunction with a J-bolt.

### SUMMARY

In concordance with the instant disclosure, a rocker body assembly that may accommodate varying sizes of truck axles while providing proper fit and clamping force on the axle in conjunction with a J-bolt, has been surprisingly discovered. The present technology includes articles of manufacture, systems, and processes that relate to devices for the transportation of vehicles and, more particularly, to an improved rocker body assembly for coupling vehicles together for transport.

In certain embodiments, a rocker assembly for a saddle-mount for towing a vehicle is provided. A bolster may be placed on a towing vehicle and a head assembly including a base may be positioned on the bolster. The head assembly may further include a clamp assembly pivotably connected to the base and designed to connect to the front axle of the vehicle being towed. The clamp assembly may include a rocker body and a J-bolt. The J-bolt may be slidably disposed through the rocker body, where a rotation of a fastener threadbly engaged with the J-bolt adjusts the position of the J-bolt relative to the rocker body to selectively secure the front axle of the towed vehicle to the rocker body.

In certain embodiments, a rocker body assembly is provided for facilitating coupling a towed vehicle to a towing vehicle. The rocker body assembly may include a rocker body including a bore, a hook, a primary surface, and a channel. The rocker body may include a top surface and a bore having an oval cross section formed through the rocker body. A hook may be formed on the top surface of the rocker body. The primary surface may be formed on the top surface of the rocker body adjacent the hook and the channel may be formed in the primary surface extending into the oval cross section of the bore.

In certain embodiments, a method of coupling a towed vehicle to a towing vehicle may include providing a rocker body. The rocker body may include a top surface with a hook formed thereon, a bore, and a primary surface. The bore may include an oval cross-section formed through the rocker body. The primary surface may be formed on the top surface adjacent the hook. In certain embodiments, the method may include positioning the rocker body to receive an axle of the towed vehicle and providing a J-bolt having a threaded end and a hook end. The J-bolt may be slidably disposed through the bore and a channel formed in the primary surface. In certain embodiments, the method may further include placing a washer/lock-plate onto the threaded end of the J-bolt and engaging a threaded fastener with the threaded end of the J-bolt to generate a clamping force securing the axle between the hook of the rocker body and the hook end of the J-bolt.

In certain embodiments, a rocker body assembly for facilitating coupling a towed vehicle to a towing vehicle may include a rocker body, a hook, a crescent shaped bore formed on a side of the rocker body, a primary surface formed on the top surface of the rocker body having a top surface, a first end and a second end, a hook formed on the top surface of the rocker body. A bore including a crescent shaped surface may be formed on a side of the rocker body adjacent the hook. The crescent shaped bore may have an oval cross-section formed through the rocker body between the first end and the second end. A channel may be formed in the primary surface and extending into the oval cross-section of the bore. The primary surface may be formed on the top surface of the rocker body adjacent the hook. The rocker body assembly may further include a J-bolt having a threaded end and a hook end, where a washer may be positioned on the threaded end of the J-bolt. A threaded fastener may be engaged with the threaded end of the J-bolt to generate a clamping force securing the axle between the hook of the rocker body and the hook end of the J-bolt.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram depicting aspects of a rocker body assembly for facilitating coupling a towed vehicle to a towing vehicle, according to an embodiment of the present disclosure.

FIG. 2 is a front perspective view of a rocker body for facilitating coupling a towed vehicle to a towing vehicle including a crescent shaped surface formed on a side of the rocker body, according to an embodiment of the present disclosure.

FIG. 3 is a bottom perspective view of a rocker body for facilitating coupling a towed vehicle to a towing vehicle including a crescent shaped surface formed on a side of the rocker body, according to an embodiment of the present disclosure.

FIG. 4 is a front elevational view of a rocker body for facilitating coupling a towed vehicle to a towing vehicle, according to an embodiment of the present disclosure.

FIG. 5 is a back elevational view of a rocker body for facilitating coupling a towed vehicle to a towing vehicle, according to an embodiment of the present disclosure.

FIG. 6 is a top plan view of a rocker body for facilitating coupling a towed vehicle to a towing vehicle, according to an embodiment of the present disclosure.

FIG. 7 is a bottom plan view of a rocker body for facilitating coupling a towed vehicle to a towing vehicle, according to an embodiment of the present disclosure.

FIG. 8 is a side elevation view of a rocker body for facilitating coupling a towed vehicle to a towing vehicle including a crescent shaped surface formed on a side of the rocker body, according to an embodiment of the present disclosure.

FIG. 9 is a rear perspective view of a rocker body for facilitating coupling a towed vehicle to a towing vehicle including a J-bolt, a washer, and a fastener, according to an embodiment of the present disclosure.

FIG. 10 is a left side elevational view of a standard rocker body including a crescent shaped surface formed on a side of the rocker body and depicting the fit to a large front axle, according to an embodiment of the present disclosure.

FIG. 11 is top perspective view depicting aspects of a rocker body assembly for facilitating coupling a towed vehicle to a towing vehicle including a substantially flat surface formed on a side of the rocker body, according to an embodiment of the present disclosure.

FIG. 12 is a bottom perspective view of a rocker body including a substantially flat surface formed on a side of the rocker body, for facilitating coupling a towed vehicle to a towing vehicle, according to an embodiment of the present disclosure.

FIG. 13 is a front perspective view of a rocker body for facilitating coupling a towed vehicle to a towing vehicle including a J-bolt and a fastener including a substantially flat surface formed on a side of the rocker body, according to an embodiment of the present disclosure.

FIG. 14 is a left side elevational view of a rocker body for facilitating coupling a towed vehicle to a towing vehicle including a J-bolt and a fastener including a substantially flat surface formed on a side of the rocker body depicting the fit to a large front axle, according to an embodiment of the present disclosure.

FIG. 15 is a left side elevational view of a prior art standard rocker body depicting the fit to a large front axle, according to an embodiment of the present disclosure.

FIG. 16 is a method of coupling a towed vehicle to a towing vehicle, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

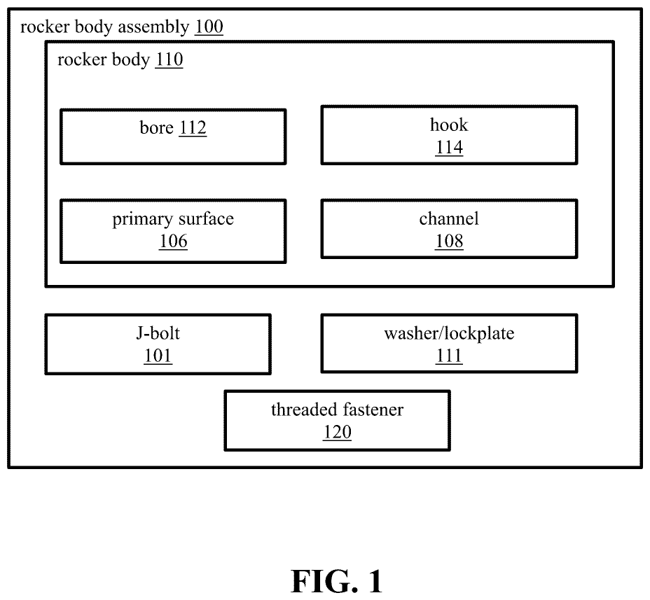

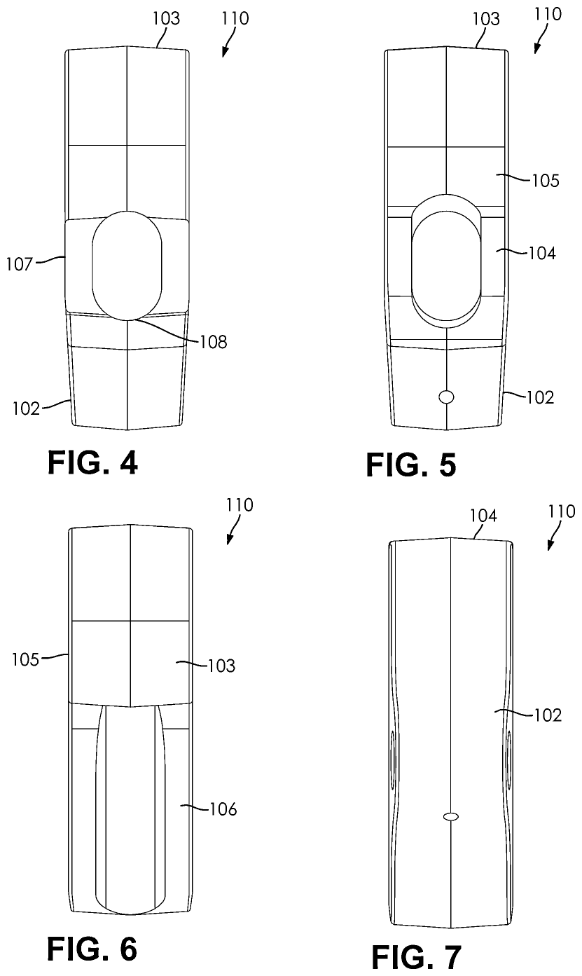

The present technology relates to a rocker body assembly 100 and a rocker body 110 for a saddle-mount, as shown generally in FIGS. 1-14. The rocker body 110 may be configured to be used in combination with a J-bolt 101, in a saddle-mount head assembly. As a non-limiting example, the saddle-mount may include a saddle-mount bolster, which is configured to be disposed on the towing vehicle. A head assembly may be disposed on the bolster. The head assembly is configured to receive the vehicle to be towed. It should be appreciated that the head assembly of the present disclosure may be utilized with a variety of bolsters. As non-limiting examples, suitable bolsters include frame style, fifth wheel style and combination style bolsters. A skilled artisan may select other suitable bolsters and methods of attachment, as desired.

In certain embodiments, the head assembly may have a head. The head may be disposed on the bolster. The head may have at least one clamp assembly disposed thereon. The clamp assembly may be pivotably attached to the head by a rocker pin. As one non-limiting example. The clamp assembly may receive an axle of the vehicle to be towed, in operation. In a more particular embodiment, the head assembly may have a plurality of clamp assemblies. As a non-limiting example, the head assembly may have two clamp assemblies.

The clamp assembly may include the rocker body 110 and the J-bolt 101. In certain embodiments, the clamp assembly and saddle mount may include a truck saddle-mount with j-clamp, for example, as further described in U.S. Pat. No. 12,077,023 to Ritchey et al., and a truck saddle mount and J-clamp, for example, as further described in U.S. Patent Application Publication No. 2024/0399805 to Ritchey et al., the entire disclosures of which are incorporated herein by reference. In other embodiments, for example, the clamp assembly may include a high strength J-bolt, for example, as further described in U.S. Patent Application titled High Strength J-Bolt to inventors Larry Steven Ritchey and Andrew Patrick Ritchey, co-filed herewith and having U.S. patent application Ser. No. ______, the entire disclosure of which is incorporated herein by reference.

The J-bolt 101 may include a hook end 113 and a straight/threaded end 112. The J-bolt 101 may be slidably disposed in the rocker body 110. The J-bolt 101 may be selectively secured to the rocker body 110 with a threaded fastener 120. More specifically, the J-bolt 101 may be disposed through the rocker body 110 and may be threaded with a fastener 120. It should be appreciated that a position of the J-bolt 101 relative to the rocker body 110 may be controlled by a rotation of a threaded fastener 120.

The rocker body assembly 100 may include rocker body 110 including a bore 104 with a crescent shaped surface 107 formed on a side of the rocker body 110. The rocker body 110 may further include a primary surface 106 formed on the top surface 103 of the rocker body 110, a first end 122, and a second end 123. A hook 114 may be formed on the top surface 103 of the rocker body 110. The crescent shaped surface 107 may be formed on a side of the rocker body 110 adjacent the hook 114. The bore 104 may include an oval cross-section formed through the rocker body 110 between the first end 122 and the second end 123. A channel 108 may be formed in the primary surface 106 that extend into the oval cross-section of the bore 104. The primary surface 106 may be formed on the top surface 103 of the rocker body 110 adjacent the hook 114.

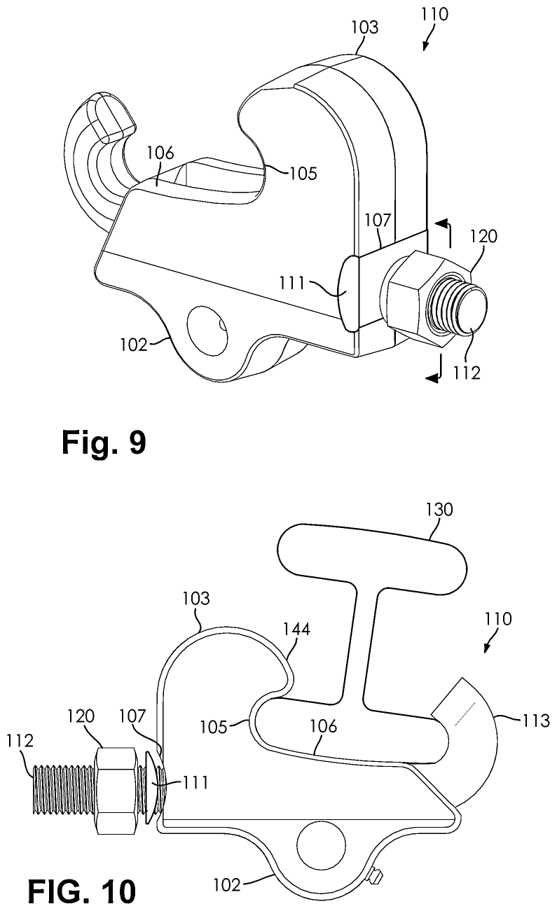

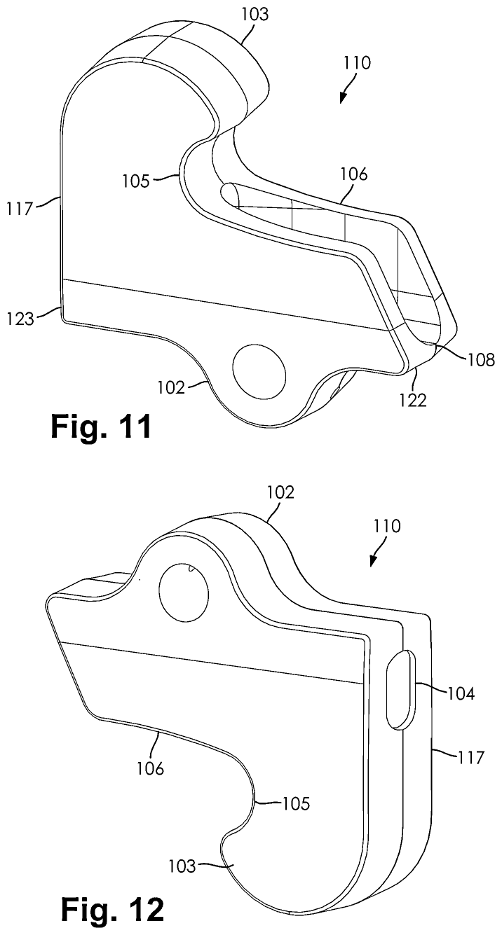

In certain embodiments, the rocker body assembly 100 may further include a J-bolt 101 having a threaded end 112 and a hook end 113, where a washer 111 may be positioned on the threaded end 112 of the J-bolt 101, such as shown within FIG. 9. A threaded fastener 120 may be engaged with the threaded end 112 of the J-bolt 101 to generate a clamping force securing the vehicle axle 130 between the hook of the rocker body 114 and the hook end of the J-bolt 113. As shown within FIGS. 11-14 the bore 104 may alternatively include a flat surface 117 in place of the crescent shaped surface 107. In particular, the rocker body 110 and the bore 104 may be shaped as appropriately desired for appropriate strength, engagement, and torsional strength. In certain embodiments, the washer may include a washer/lock-plate such as further described in U.S. patent application Ser. No. 18/750,322 to Ritchey et al., the entire disclosure of which is incorporated herein by reference.

The rocker body 110 may have a projection 102 formed in a bottom surface thereof. The projection 102 may be semicircular in shape. The projection 102 may be disposed in the head by means of a rocker pin. In operation, the rocker body 110 may rotate about the rocker pin. Advantageously, the rotation of the rocker body 110 may militate against torque in a clamp assembly, in operation.

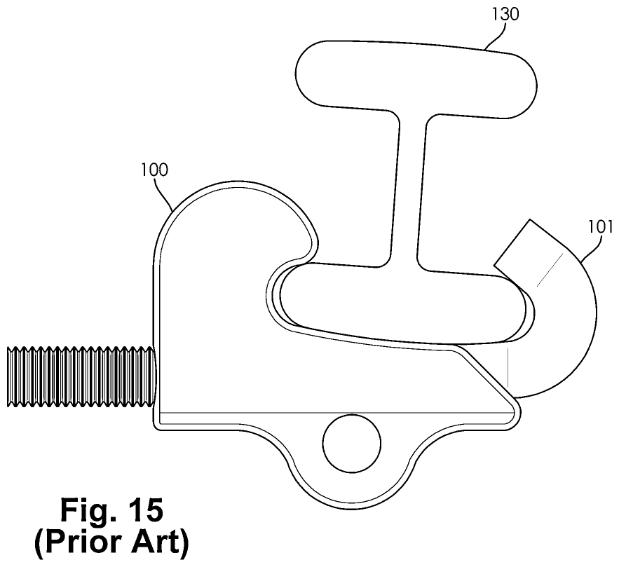

The hook 114 may be formed to engage a portion of an axle of the towed vehicle. In certain embodiments, the inside radius 105 of the hook 114 may be from about 0.60 inches to 0.65 and a depth of the hook 114 may be from about 0.25 inches to 0.65 inches. In certain embodiments the inside radius 105 of the hook 114 may be about 0.630 inches and a depth of the hook 114 may be about 0.40625 inches ( 13/32nds and inch). It should be understood that other dimensions for the inside radius 105 of the hook and the depth of the hook may be selected to accommodate a required functional or manufacturing requirement. It should be appreciated that in use, the threaded fastener 120 may be rotated to cause the hook end 113 of the J-bolt 101 to move toward the hook 114 to slidably engage and secure the axle 130 of the vehicle between the hook 114 of the rocker body 110 and the hook end 113 of the J-bolt 101. As shown in FIGS. 10 and 14, the hook 114 may be configured to accommodate a larger truck axle 130 where the axle may be more fully received by the hook 114 and a portion of the axle is received and is adjacent and/or abutting the surface forming the inside radius 105 of the hook 114. As shown in FIGS. 10 and 14, the hook 113 may be configured to accommodate larger truck axles wherein the axle may be more fully received by the hook 114 where a portion of the axle is received and is adjacent and/or abutting the surface forming the inside radius 105 of the hook 114. This is in contrast to the prior art standard rocker shown in FIG. 15 where the portion of the axle 130 may not be fully received between the inside radius 105 of the hook 114 and the portion of the axle 130 received by the hook 114.

The nose of the hook 114 may also be configured to minimize contact with a web of an I-Beam axle. For example, the distance from the surface of the inside radius 105 to the nose or end of the hook 114 may be about 0.650 inches or less to provide a desired engagement with a portion of the axle and minimize a likelihood that the web of the axle will contact the nose of the hook 114.

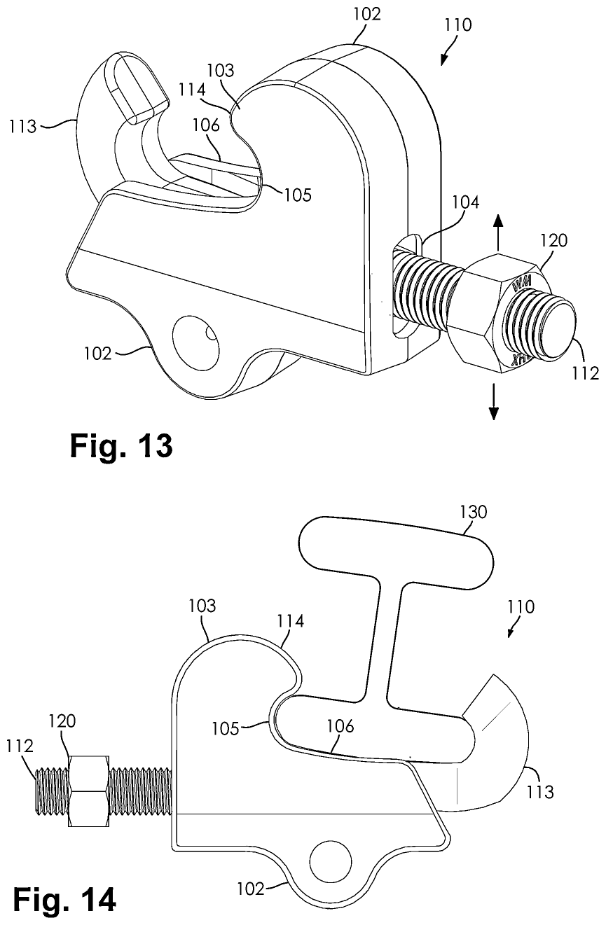

The bore 104 provides an opening through the rocker body 110 to receive the straight/threaded end 112 of the J-bolt 101 therethrough. In certain embodiments, the width of the bore 104 may be from about 1 inch to 1.375 inches and the height of the bore may be from about 1.5 inches to 2 inches. In certain embodiments, the width of the bore 104 may be about 1.1875 inches and the height of the bore may be about 1.6875 inches. The oval cross-section of the bore 104 allows the J-bolt 101 to vertically align itself within the bore 104 when it is tightened to accommodate axles of various sizes thereby reducing the bending forces on the J-bolt 101 that may occur if it is misaligned. For example, as represented by the arrows shown in FIG. 13, the J-bolt 101 may move vertically within the height of the oval cross-section of the bore 104 so that when the J-bolt 101 is tightened, the hook end 113 of the J-bolt 101 may optimally engage and secure the axle 130 of the vehicle. Movement of the J-bolt 101 may include adjusting an angle of the J-bolt 101 within the height of the oval cross-section of the bore 104 so that when the J-bolt 101 is tightened, the hook end 113 of the J-bolt 101 may optimally engage and secure the axle 130 of the vehicle.

The primary surface 106 may be configured to abut a surface of the axle 130 of the towed vehicle, such as shown in FIGS. 10 and 14. The primary surface 106 may have a curved surface having a radius of between about 10.50 inches and 11.25 inches. The primary surface 106 may have a curved surface having a radius of about 10.875 inches.

The rocker body 110 may have a channel 108 formed in the primary surface 106 and adjacent to and extending into the bore 104. The channel 108 may have a U-shaped cross-section. A skilled artisan may select other suitable shapes for each of the bore 104 and the channel 108. The J-bolt 101 may be slidably disposed in the channel 108 of the rocker body 110, including a portion of the J-bolt 101 slidably disposed in the bore 104 of the rocker body 110. The U-shape of the channel 108 is designed to cooperate with the J-bolt 101 and mitigate against the J-bolt 101 and the clamp assembly from rotating in operation, providing a more secure attachment of the rocker body 110 and the clamp assembly and to the axle.

It should be appreciated that the oval cross-sectional shape of the bore 104 and the U-shaped cross-section of the channel 108 cooperate to facilitate a secure attachment of the rocker body 110 and the clamp assembly to the vehicle axle 130. More particularly, the U-shaped cross-section of the bore 104 and the channel 108 may be deep enough (the distance from the primary surface 106, through the channel 108, and to the bottom of the bore 104) to allow the vehicle axle 130 and weight of the towed vehicle to rest on the primary surface 106 of the rocker body 110 while the J-bolt 101 may move free of vertical load from the vehicle axle 130 within the channel 108 and the bore 104 to accommodate different size axles. This militates against additional stress being applied to the J-bolt 101 that could occur if the weight of the vehicle axle 130 would rest on the J-bolt 101.

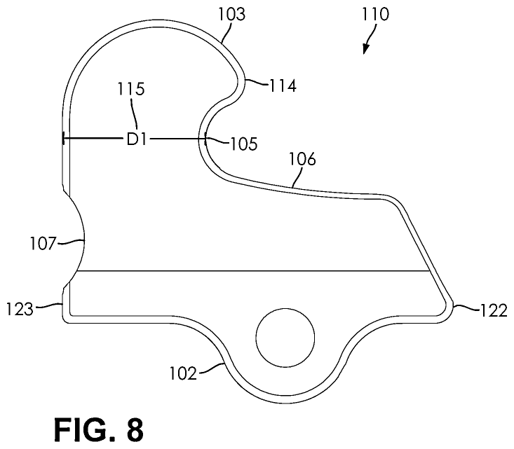

The rocker body 110 may also include a throat 115. The throat 115 may defined as the shortest distance from the inside radius 105 of the hook 114 to the front of the rocker body 110 (the front of the rocker body 110 being the surface opposite the hook 114 that includes the oval opening of the bore 104 and the crescent shaped surface 107) and have a distance D1 as shown within FIG. 8. The throat 115 may have a thickness (the shortest distance from the inside radius 105 of the hook 114 to the front of the rocker body 110) of about 2.50 inches. The thickness of the throat 115 provides increased strength to the rocker body 110 and the hook 114 of the rocker body 110 as compared to other rocker bodies. The increased strength also militates against a mechanical or material related failure in the rocker body 110 which helps to maintain the coupling of the towed vehicle to the tow vehicle both in towing operations and in the event that the towed vehicle and the tow vehicle are involved in an accident.

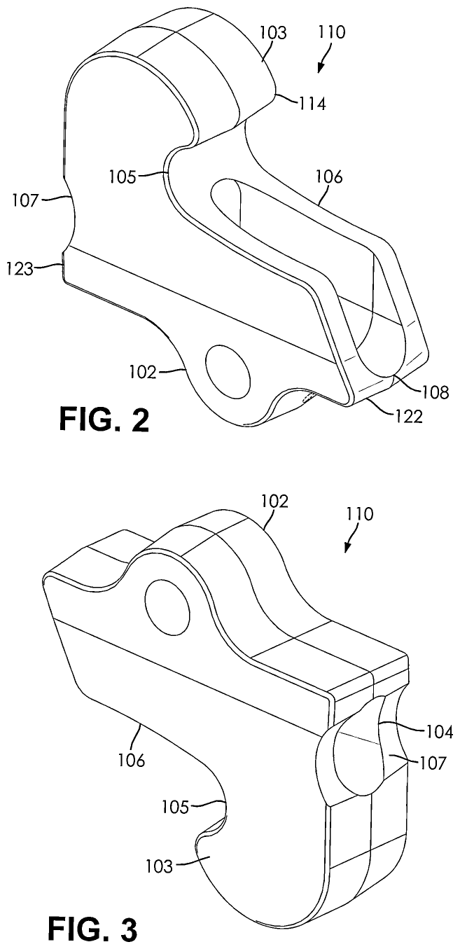

In certain embodiments, such as particularly shown in FIGS. 2, 3, and 8, the bore 104 may include a crescent shaped surface 107. The crescent shaped surface 107 allows the J-bolt to rotationally align itself within the bore 104 that is configured to reduce torque during tightening of a washer 111 and threaded faster 120 on the J-bolt 101. The crescent shaped surface 107 and the bore 104 may include the channel 108 which may increase engagement between the vehicle axle 130 and the primary surface 106. In particular, the crescent shaped surface 107 of the bore 104 cooperates with the channel 108 to facilitate movement of the J-bolt 101 free of vertical load from the axle 130.

Advantageously, the crescent shaped surface 107 of the bore 104 enables rotational alignment of the J-bolt 101 with the vehicle axle 130 and the rocker 110 within the bore 104, which may reduce torque during the tightening process when securing the washer 111 and threaded faster 120 to the J-bolt 101. Additionally, the washer 111 may include a crescent shape, as shown in FIG. 9, such that the washer 111 may mate and/or cooperate with the crescent shaped surface 107 of the bore 104 in order to enable a proper rotational alignment of the J-bolt with the vehicle axle 130 to optimally engage and secure the axle. The washer 111 including a crescent shape may also enable the threaded faster 120 to remain properly aligned with respect to the rocker body as the washer 111 is seated into the crescent shaped surface 107 when the threaded fastener is tightened onto the J-bolt 101. The washer 111 may move into or otherwise align with the crescent shaped surface 107 such that the washer 111 may pivot thereby allowing the threaded fastener 120 a flat surface normal to the clamping force thereby reducing the bending stresses and torque applied to the washer 111, the J-bolt, and the threaded fastener 120. In particular, the crescent shaped surface 107 may allow it to rotate while maintaining a flat surface normal to the J-bolt for the threaded fastener 101 to tighten to.

It should be appreciated that the crescent shaped surface 107 and the U-shaped cross-section of the channel 108 cooperate to facilitate a secure attachment of the rocker body 110 and the clamp assembly to the vehicle axle 130. More particularly, the U-shaped cross-section of the bore 104 and the channel 108 may be deep enough (the distance from the primary surface 106, through the channel 108, and to the bottom of the bore 104) to allow the vehicle axle 130 and weight of the towed vehicle to rest on the primary surface 106 of the rocker body 110 while the J-bolt 101 may pivot free of vertical load from the vehicle axle 130 within the channel 108 and the bore 104 to accommodate different size axles. This militates against additional stress being applied to the J-bolt 101 that could occur if the weight of the vehicle axle 130 would rest on the J-bolt 101.

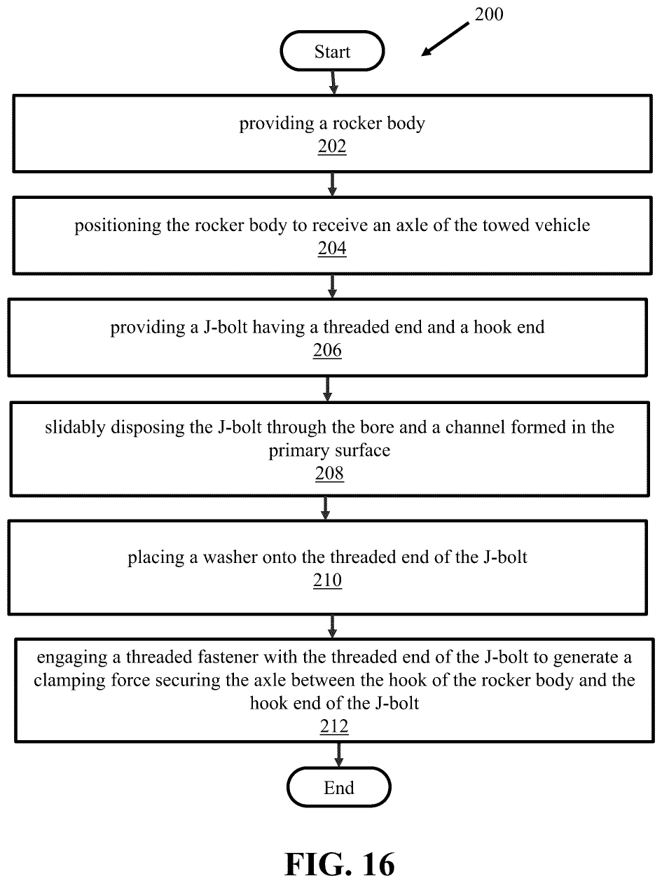

As shown within FIG. 16, a method 200 of coupling a towed vehicle to a towing vehicle may include a first step 202 of providing a rocker body 110, such as described above. A second step 204 may include positioning the rocker body 110 to receive an axle of the towed vehicle and in a third step 206, providing a J-bolt having a threaded end and a hook end. A fourth step 208 may include slidably disposing the J-bolt 101 through the bore 104 and a channel 108 formed in the primary surface 106. In certain embodiments, a fifth step 210 may include placing a washer 111 onto the threaded end 112 of the J-bolt 101. Then, in a sixth step 212 a threaded faster 120 may engage with the threaded end 112 of the J-bolt 101 to generate a clamping force securing the axle between the hook 114 of the rocker body 110 and the hook end 113 of the J-bolt 101.

### EXAMPLES

Installation and operation of the rocker body assembly can include the following aspects.

A rocker body assembly may be installed on a saddle-mount head assembly by first positioning the rocker body on the head assembly using a rocker pin through a projection formed in a bottom surface. A J-bolt may then be slidably disposed through an oval bore and channel of the rocker body, with the threaded end extending through the bore. A crescent shaped washer may be placed onto the threaded end of the J-bolt, followed by engaging a threaded fastener with the J-bolt.

A crescent shape washer may rotate with the J-Bolt to provide a flat surface for the Nut and Lock Washer to tighten up against. This may reduce the bending stress on the J-Bolt that would result if the tightening surface were not flat. This may also reduce torque and ensure proper engagement of the J-bolt and an axle. The channel depth may allow the J-bolt to remain below a primary surface, ensuring the axle weight is supported by the primary surface of the rocker body rather than the J-bolt. This configuration militates against additional stress being applied to the J-bolt that could occur if the weight of the vehicle axle would rest on the J-bolt.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A rocker body assembly for coupling an axle of a towed vehicle to a towing vehicle, the rocker body assembly comprising
a rocker body having a top surface, the rocker body including
a bore having an oval cross section formed through the rocker body,
a hook formed on the top surface of the rocker body,
a primary surface formed on the top surface of the rocker body adjacent the hook;
a channel formed in the primary surface and extending into the oval cross section of the bore.

2. The rocker body assembly of claim 1, wherein the bore includes a width being from about 1 inch to 1.375 inches and a height of from about 1.5 inches to 2 inches.

3. The rocker body assembly of claim 1, wherein the primary surface is configured to abut a surface of the axle of the towed vehicle.

4. The rocker body assembly of claim 1, further comprising a J-bolt having a threaded end and a hook end that is slidably disposed in the channel and the bore of the rocker body.

5. The rocker body assembly of claim 4, wherein the oval cross section of the bore is configured to facilitate vertical alignment of the J-bolt within the bore when coupling the axle of the towed vehicle.

6. The rocker body assembly of claim 5, further comprising a threaded fastener that cooperates with the threaded end of the J-bolt and the rocker body to generate a clamping force on the axle of the towed vehicle when the axle is disposed between the hook of the rocker body and the hook end of the J-bolt.

7. The rocker body assembly of claim 5, wherein the channel formed in the primary surface extends into the bore to facilitate a movement of the J-bolt free of vertical load from the axle.

8. The rocker body assembly of claim 5, wherein the channel formed in the primary surface extends into the bore to facilitate the J-bolt applying a clamping force to the axle of the towed vehicle.

9. The rocker body assembly of claim 1, wherein the hook includes an inside radius, the inside radius being from about 0.60 inches to about 0.65 inches.

10. The rocker body assembly of claim 9, wherein a throat of the hook is about 2.5 inches to facilitate selectively securing the axle of the towed vehicle to the rocker body.

11. The rocker body assembly of claim 1, wherein the primary surface includes a curved surface having a radius of about 10.875 inches.

12. The rocker body assembly of claim 4, including a bore having a crescent shaped surface formed on a side of the rocker body adjacent the hook, wherein the crescent shaped surface of the bore is configured to facilitate level seating of the J-bolt against the primary surface.

13. The rocker body assembly of claim 12, wherein the crescent shaped surface of the bore enables rotational alignment of the J-bolt within the bore that is configured to reduce torque during tightening of a threaded fastener on the J-bolt.

14. The rocker body assembly of claim 13 further comprising a washer including a crescent shape, the crescent shape corresponding to the crescent shaped surface, where the washer is configured to pivot to seat within the crescent shaped surface and the corresponding flat surface of the crescent is configured to abut the threaded fastener normal to the J-bolt when it is tightened reducing the bending forces and torque.

15. The rocker body assembly of claim 14, wherein the crescent shape of the washer cooperates with the crescent shaped surface to enable a flush contact between the washer and crescent shaped surface when the threaded fastener is tightened on the J-bolt.

16. A method of coupling a towed vehicle to a towing vehicle comprising:
providing a rocker body having a top surface with a hook formed thereon, a bore having an oval cross-section formed through the rocker body, and a primary surface formed on the top surface adjacent the hook;
positioning the rocker body to receive an axle of the towed vehicle;
providing a J-bolt having a threaded end and a hook end;
slidably disposing the J-bolt through the bore and a channel formed in the primary surface; and
engaging a threaded fastener with the threaded end of the J-bolt to generate a clamping force securing the axle between the hook of the rocker body and the hook end of the J-bolt.

17. The method of claim 16, further comprising vertically aligning the J-bolt within the oval cross-section of the bore.

18. The method of claim 16, further comprising placing a crescent shaped washer onto the threaded end of the J-bolt, the crescent shaped washer corresponding to a crescent shaped surface formed on a side of the rocker body adjacent the hook.

19. The method of claim 18, further comprising tightening the threaded fastener to generate a clamping force securing the axle between the hook of the rocker body and the hook end of the J-bolt.

20. A rocker body assembly for facilitating coupling a towed vehicle to a towing vehicle, the rocker body assembly comprising:
a rocker body having a top surface, a first end and a second end;
a hook formed on the top surface of the rocker body;
a bore including a crescent shaped surface formed on a side of the rocker body adjacent the hook, the bore having an oval cross-section formed through the rocker body between the first end and the second end;
a primary surface formed on the top surface of the rocker body adjacent the hook;
a channel formed in the primary surface and extending into the oval cross-section of the bore;
a J-bolt having a threaded end and a hook end;
a washer positioned on the threaded end of the J-bolt; and
a threaded fastener engaged with the threaded end of the J-bolt to secure the washer against the rocker body.
